(19) United States
(12) Patent Application Publication
(10) Pub. No.: US 2014/0166326 A1
(43) Pub. Date: Jun. 19, 2014

(54) Electric Impulse Screwdriver

(71) Applicants: Nicolas Le Du, Coueron (FR); Julien Tropee, Nantes (FR)

(72) Inventors: Nicolas Le Du, Coueron (FR); Julien Tropee, Nantes (FR)

(73) Assignee: ETABLISSEMENT GEORGES RENAULT, Saint-Herblain (FR)

(21) Appl. No.: 14/113,181

(22) PCT Filed: Apr. 20, 2012
(86) PCT No.: PCT/EP12/57320

§ 371 Date: Feb. 10, 2014

(30) Foreign Application Priority Data
Apr. 21, 2011 (FR) 1153461

(51) Int. Cl. B25B 23/147; B25B 21/00

(52) U.S. Cl. CPC B25B 23/147; B25B 21/00
USPC 173/181

(57) ABSTRACT

An electric screwdriver includes a housing, a motor having a rotor and a maximum torque at constant speed of Cmax, and an end member. A transmission drives the end member and has a reduction gear coupled to the motor and having a ratio R and an efficiency μ. A torque sensor detects an attainment of a set value torque Cc. A motor driver drives the motor with a series of electric current impulses, The transmission enables an accumulation of kinetic energy Ec in the rotor and a restitution to the end member of the kinetic energy Ec between two impulses from the motor driver. The motor and reduction gear are configured such that: R*μ*Cmax<Cc, the set value of torque Cc being attained through the transfer of kinetic energy Ec to the end member, wherein ratio R is smaller than or equal to 10/(μCmax).

### 1. CROSS-REFERENCE TO RELATED APPLICATIONS

This Application is a Section 371 National Stage Application of International Application No. PCT/EP2012/057320, filed Apr. 20, 2012, which is incorporated by reference in its entirety and published as WO 2012/143532 on Oct. 26, 2012, not in English.

### 2. FIELD OF THE INVENTION

The field of the invention is that of the designing and fabrication of portable electric tools. More specifically, the invention pertains to an electric impulse screwdriver.

Screwdrivers are used to tighten an assembly, i.e. to connect several parts together for example by means of a screw.

### 3. PRIOR ART

An impulse screwdriver generally comprises a body defining a handle. This body has:
motor means provided with a rotor;
an end member that can be driven rotationally by a transmission including an epicyclic type of reduction gear coupled with motor means;
a torque sensor to detect the attaining of a set torque value Cc, the transmission comprising a ring rotationally linked to the housing of the screwdriver by means of this torque sensor;
means for driving the motor means in pulsed mode to feed the motor means with a series of impulses.

In the field of the invention, electric screwdrivers working by impulses, i.e. by the application of a torque for a short period, repeated periodically, have appeared recently, competing with pneumatic impact wrenches or traditional hydropneumatic wrenches. Indeed, electric impulse screwdrivers preserve the advantages of hydropneumatic or pneumatic impulse wrenches in terms of high levels of torque, while at the same time enabling better control of the level of tightening torque.

Now, at the industrial level, it is often sought to be able to carry out tightening operations by screwing with a high level of precision.

For tool performance, the designer of an electric impulse screwdriver must deal with several parameters related to the tool and/or its purpose. These are:
the maximum torque at constant speed of the motor of the screwdriver;
the reduction ratio of the transmission and its efficiency;
the tightening requirement that the tool must meet.

Since the tightening torque Cs exerted on the screw to be tightened is governed by the equation Cs=R*μ*Cmax (R is the reduction ratio and Cmax is the maximum torque of the motor of the tool at constant speed in N.m. and μ is the efficiency of the reduction which is smaller than 1), the designer's classic and constant approach is to size the motor and the reduction in such a way that the output torque can attain the set value of torque, namely the tightening goal to be achieved.

The operator must furthermore take the following elements into consideration:
the productivity of the tool and especially its capacity to execute a tightening operation at high speed;
the stresses imposed on the user of the tool owing to the transmission of impacts and tremors at each impulse of the screwdriver.

In order to reduce the duration of execution of a tightening operation, a tightening operation generally comprises two successive phases:
a phase of pre-screwing, in continuous mode, i.e. at a constant high speed of rotation and with a tightening torque of a value smaller than the set torque value Cc at which it is desired to tighten the screw, and
a phase of screwing by impulses until the set torque value Cc is reached.

The majority of impulse screwdrivers are pistol-handle tools. They can be used to tighten screws at levels of torque that appreciably exceed the levels that an operator could withstand in the context of a continuous tightening speed.

However, these tightening levels are possible because the torque impulses are brief and because the inertia of the body of the tool absorbs a part of the tightening torque.

At present, electric impulse screwdrivers generate torque impulses of a duration of the order of 10 ms. This duration, which is far too lengthy given the inertial mass of the body of the tool, does not attenuate the tightening reaction in the operator's hand sufficiently for satisfactory comfort. The reaction force in the operator's hand, which is expressed by the operator's hand being driven rotationally by the screwdriver along the screwing axis, is therefore generally too great. This has unpleasant consequences, for example the appearance of muscular-skeletal disorders, for the operator. In other words, currently used electric impulse screwdrivers do not give an appropriate level of comfort of use, or at least a level of comfort comparable with that offered by hydropneumatic wrenches.

Besides, for an output torque of the order of 30 N.m, the nominal speed of electric impulse screwdrivers is of the order of 1000 rpm while that of pneumatic impact or hydropneumatic impact wrenches is of the order of 5000 rpm. The time taken for a screwing operation with an electric impulse screwdriver is therefore appreciably greater. The productivity of this type of screwdriver is therefore not as good as that of pneumatic or hydropneumatic impulse wrenches.

Furthermore, for operations of joining known as “hard joining”, where the angle of rotation of the screw, between the instant when the tightening of the part begins and the instant when the final tightening reached is attained, is small, i.e. less than 30°, it can happen that the set value of torque to be obtained is exceeded at the end of the pre-screwing operation. This is because the kinetic energy accumulated by the rotor is returned to the screw, this rotor being inadequately braked by the electric tool-driving means provided for this purpose. The rotation speed of the motor then needs to be reduced in order not to exceed the set value of torque at the end of pre-screwing operation. This leads to even further reducing the rotation speed during the pre-screwing operation and therefore productivity.

According to another aspect, present-day electric impulse screwdrivers are directly derived from electric screwdrivers working in continuous mode. Their reduction ratio is therefore such that they are capable, in continuous mode, of delivering a torque that is equivalent to the torque delivered by screwdrivers working in continuous mode. However, an operator is incapable of continuously undergoing a reaction torque greater than about 10 N.m unless he has a reaction bar designed to stop the housing of the tool in rotation as is the case with screwdrivers working conventionally in continuous mode. Thus, if an electric impulse screwdriver is mistakenly used not in impulse mode but in continuous mode, the reaction of the tool received by the operator's hands is appreciably greater than what he is capable of withstanding. This gives rise to a risk of injury for the operator.

### 4. SUMMARY OF THE INVENTION

An embodiment relates to an electric screwdriver comprising:
a housing;
motor means, of the maximum torque at constant speed is Cmax, provided with a rotor;
an end member capable of being driven in rotation by a transmission including a reduction gear coupled to the motor means and having a ratio R and an efficiency μ;
at least one torque sensor for detecting the attaining of an set value torque Cc;
means for driving the motor means in impulse mode, intended for feeding the motor means with a series of impulses;

said transmission being capable of enabling an accumulation of kinetic energy Ec in the rotor and a restitution to the end member of said kinetic energy Ec between two impulses, and the motor means and the reduction gear being configured in such a way that:

R*μ*Cmax<Cc, the set value of torque Cc being attained through the transfer of kinetic energy Ec to the screw to be tightened.

According to the invention, said ratio R is smaller than or equal to 10/(μCmax).

In the international system, Cmax and Cc are classically expressed in N.m. μ is smaller than 1.

The implementation of the invention makes it possible especially:
to preserve the operator's state of health by considerably reducing his perception of the impulses, this perception being reduced to a threshold that causes him no discomfort;
ensure a pre-screwing speed comparable to that of hydropneumatic tools and thus give the tool of the invention high productivity;
improve safety of use inasmuch as the reaction to the screwing operation that the operator undergoes if the screwdriver is mistakenly used in continuous mode and not in impulse mode, is reduced.

The Applicant has noted that, in present-day electric impulse screwdrivers, the mechanical torque impulses can appear after the electric supply impulses of the stator and are staggered in time, especially if these electric impulses are sufficiently brief. This can be explained as follows.

Conventionally, the transmission of a screwdriver comprises a functional (angular) clearance needed for the efficient operation of the pinions. When the stator of the motor is fed with an electric current impulse, it accelerates the rotor within the limit of this angular clearance and then, once the play has been absorbed, the rotor transmits its kinetic energy, in an impact, to the screw thus creating a torque impulse. During each torque impulse, also called a mechanical impulse, the kinetic energy of the rotor is then transmitted by the transmission unit from the screwdriver to the end member.

The motor is not powered with electric current during the torque impulses. It therefore does not generate any electromagnetic torque during these torque impulses. Thus it is the restitution of its kinetic energy to the end member of the tool, and not the electromagnetic torque generated by the motor, that is decisive for attaining the set value of torque. The value of the reduction ratio therefore does not play a role as such in the restitution of this kinetic energy.

The evaluation of the forces and dynamic phenomena that can be applied to the body of the tool leads to the following considerations.

For easy presentation, the following assumptions have been made:
The operator exerts a negligible holding force on the handle of the tool, this being compliant with one of the goals of the invention which is to reduce the reaction of the tool in the operator's hand.
The transmission is an epicyclic reduction gear and the dynamic phenomena which apply to the planet carrier of this reduction gear and to the end member of the tool are overlooked in relation to those applying to the rotor of the stator.
The motor is not powered during the torque impulse on the screw, and the electromagnetic torque exerted on the stator of the motor fixedly joined to the body of the tool on the rotor is therefore zero.

The torque sensor is mounted between the body of the screwdriver and the ring gear of the epicyclic reduction gear to stop it in rotation in the body of the tool.

For an epicyclic reduction, the relationship between the torque applied on the screw and the torque measured by the torque sensor can be expressed by the following relationship:

\vec{M}scewing.(1−1/(R·μ))=\vec{M}sensor

With:
R being the reduction ratio of the epicyclic reduction gear;
μ being the efficiency of the epicyclic reduction gear;
\vec{M}screwing being the resistant torque of the screw during the screwing torque impulse;
\vec{M}sensor being the torque exerted by the sensor on the body of the tool along its screwing axis.

In isolating the assembly formed by the body of the tool, the stator of the motor and the handle and applying the fundamental principle of dynamics to it, the following relationship can be assumed:

\vec{M}sensor+\vec{M}electromagnetic+\vec{M}operator=Jbody·{dot over (\vec{W}body

With:
\vec{M}electromagnetic being the resistant electromagnetic torque exerted by the rotor on the stator, which is zero because the motor is not powered during the screwing torque impulse;
\vec{M}operator being the reaction torque exerted by the operator on the handle of the tool, which is overlooked given the goal of the invention;
Jbody being the rotor inertia of the body of the tool along the screwing axis;
{dot over (\vec{W} body being the acceleration in rotation undergone by the body of the tool along the screwing axis during the screwing torque impulse.

\vec{M}screwing·(1−1/(R·μ))=Jbody·{dot over (\vec{W}body {dot over (\vec{W}body=\vec{M}screwing·((1−1/(R·μ)/Jbody)

The acceleration to which the body of the tool is subjected induces a rotation of the body of the tool around the screwing axis in the operator's hand. The smaller the angle of rotation of the body of the tool, the lower will be the operator's perception of the torque impulses. In order to reduce the angle of rotation of the body of the tool, which is a consequence of this acceleration, it is possible to:
reduce the duration during which the body of the tool is subjected to this acceleration {dot over (\vec{W}body;
directly reduce the value of this acceleration {dot over (\vec{W}body:
   by increasing Jbody, or
   by reducing the ratio R of the transmission.

With respect to the reduction of the duration of the acceleration, the inventors have noted that, when using a reduction gear with a low reduction ratio, the rotor is subjected to a deceleration torque that is greater than when using a reduction gear having a high ratio.

Indeed, the relationship between the screwing resistant torque and the torque generated by the rotor of the motor during the torque impulse is the following:

\vec{M}screwing=−R·μ·\vec{M}rotor

\vec{M}rotor=−\vec{M}screwing/(R·μ)

With:
R being the reduction ratio of the epicyclic reduction;
μ being the efficiency of the epicyclic reduction;
\vec{M}screwing being the resistant torque of the screw during the screwing torque impulse;
\vec{M}rotor being the torque exerted by the rotor on the input of the reduction.

In applying the fundamental principle of dynamics to the rotor, it is subjected to the resistant torque of the reduction gear. The result of this therefore is that:

\vec{M}reduction=\vec{J}rotor·\vec{W}rotor

With

\vec{M}reduction=−\vec{M}rotor

It is deduced therefrom that:

{right arrow over (\dot{W}rotor=\vec{M}screwing/(R·μ·\vec{J}rotor)

Consequently, for a given screwing torque, the lower the reduction ratio, the greater the deceleration of the rotor and therefore the shorter will be the duration for which the rotor transmits its kinetic energy to the assembly.

The duration of the screwing torque impulse is therefore all the shorter as the reduction ratio is low.

In order to reduce the duration of the screwing impulses, especially from about 10 ms to about 2 ms, the inventors then divided the reduction ratio by about 5 in establishing the fact that the ratio value R is smaller than or equal to 10/(μCmax).

This is illustrated in FIG. 3 which represents curves illustrating the duration of a torque impulse respectively with a two-stage reduction, the ratio of which is equal to 20.97, and with a one-stage reduction, the ratio of which is equal to 3.81. Since the duration of the mechanical impulse is diminished, the duration for which the body of the tool is subjected to an acceleration in rotation {right arrow over (\dot{W}body is reduced. The angular shift of the screwdriver in an operator's hand during a mechanical impulse is thus very small, and this limits the operator's perception of the impulses.

The diminishing of the reduction ratio therefore contributes:
firstly to diminishing the duration for which the body of the tool is subjected to this acceleration {right arrow over (\dot{W}body, and
secondly directly diminishing the value of {right arrow over (\dot{W}body:

All this plays a part in reducing the angle of rotation of the body of the screwdriver in the operator's hand at each impulse.

The implementation of the technique according to the invention therefore nullifies the operator's perception of the impulses or at least limits them to a level that causes no discomfort. In this way, the screwdriver generates a reaction force in the operator's hand that remains below the average threshold of tolerance beyond which the operator may feel a discomfort or even an unpleasant effect. The appearance of muscular-skeletal disorders for the operator is thus prevented and the comfort of use of the impulse screwdriver is increased.

Furthermore, the reduced reduction ratio makes it possible to maintain high rotation speed for the screw that is to be tightened with a moderate rotation speed for the motor. Indeed, a low ratio makes it possible to deliver an equivalent output torque with a smaller output speed of the motor. For example, if we consider a ratio smaller than or equal to 10/(μCmax) if the motor torque is equal to 2.5 N.m and if the efficiency of the reduction is close to 1, then the ratio will be approximately equal to 4 and if the output speed of the motor is equal to 20,000 rpm, the output speed of the tool will be of the order of 5,000 rpm. The technique according to the invention thus ensures high productivity.

Furthermore, this reduction of the speed of the motor can be such that it causes a drop in the kinetic energy stored during the pre-screwing stage. The result of this is to greatly reduce the risk of exceeding the torque when the screw comes into contact with the part to be tightened, especially for hard joining, without in any way thereby reducing the productivity of the tool.

For a given output speed, the reduction of the ratio R therefore makes it possible either to reduce the speed of rotation of the motor to a value limiting the risk of exceeding the set value of torque or of preserving a speed of the motor that is technically reasonable, i.e. of the order of 20,000 rpm, while at the same time in all cases maintaining high productivity.

It can be noted that the invention is part of a problem-solving approach that runs counter to the preconceived ideas of those skilled in the art (the field of the designing of portable electric impulse screwdrivers) without acting on the conventional levers used by the designers of these tools.

Indeed, the habitual reflex that comes into play when reducing the torque spike at the point of contact is that of reducing the speed of the motor before contact. However, a designer's habitual reflex of this type would reduce the productivity of the tool, and this is not acceptable in many industrial domains using such tools, for example on assembly lines.

According to the invention, and given the nominal speed of the tool which is higher than that of a tool of classic design, the lowering of the speed of the motor nevertheless makes it possible to preserve a high level of productivity.

It must be noted that the designer is dissuaded from reducing the reduction ratio since this would lead him into a dead end where the level of output torque (equal to the multiplication of the reduction ratio by the maximum torque at constant speed of the motor) can no longer attain the set value of torque for a maximum given torque of the motor (since it is certainly conceivable that the maximum torque of the motor can be increased by choosing a more powerful motor, which nevertheless would be done to the detriment to the price of the tool and/or its space requirement and/or its weight).

Furthermore, with a tool according to the invention, owing to the low ratio, the tightening capacity in continuous mode has a ceiling that is placed at a torque value lower than that limit beyond which the operator would no longer withstand it, in this case a limit of 10 N.m. Thus, even if there is a wrong programming of the tool, there is of the operator undergoing a continuous torque that he could not withstand. For example, if the motor torque is equal to 2.5 N.m and if the ratio is equal to 4, the output torque in continuous mode will not exceed 10 N.m, which is compatible with the operator's capacity for accepting torque.

Besides, during a mechanical impulse with a given amplitude of torque, the kinetic energy transmitted by the rotor to the screw prompts a deformation of the reduction until the torque reaches the level needed to make the screw start turning and get tightened. An impulse is formed successively by a period of deformation of the transmission, a period of rotation of the screw and a period of relaxation of transmission. The stiffer the transmission, the shorter the duration of the periods of deformation and relaxation and therefore the shorter the duration of torque impulses.

To increase the stiffness of the transmission, the inventors have thought of reducing the number of stages. Indeed, the smaller the number of stages, the lower the number of parts forming the transmission, and the smaller is the torsional deformation of the transmission and the shorter is the period during which the deformation occurs. This is illustrated in FIG. 4 which expresses the relationship between the torque applied by the input sun gear of an epicyclic reduction gear or motor shaft and the angle of rotation of the sun gear or the motor shaft, the output shaft of the tool being immobilized in rotation relative to the body of the tool.

According to another aspect of the invention, the transmission is therefore of an epicyclic type and comprises only one stage instead of the usual two stages, and this plays a part in reducing the duration of the screwing impulse and therefore the duration during which the body of the tool is subjected to the acceleration {right arrow over (\dot{W}body.

This also participates in reducing the angle of rotation of the body of the screwdriver in the operator's hand at each impulse and therefore improving the security and comfort of use.

The transmission preferably has a stiffness greater than or equal to 0.5 N.m per degree, this stiffness being measured by the input sun gear of the transmission, the output shaft being immobilized in rotation relative to the body of the tool.

According to an advantageous solution, the motor means and the reduction are configured in such a way that R*μ*Cmax≦Cc/1.5.

It is possible in this approach to propose a tool for which the set value of torque can have a relatively high level, while at the same time limiting the undesired effects on the operator's hand.

In either case, the screwdriver can be parameterized with a set value torque Cc>20 N.m.

Said transmission preferably integrates an angular clearance enabling the rotor of the motor means to freely accelerate during this impulse to accumulate a kinetic energy Ec.

In one particular embodiment, said epicyclic reduction gear comprises a ring gear rotationally linked to the housing of the screwdriver by means of the torque sensor.

### 5. LIST OF FIGURES

Other characteristics and advantages of the invention shall appear more clearly from the following description of a preferred embodiment of the invention, given by way of an illustratory and non-exhaustive example and from the appended drawings, of which:

FIG. 1 is a schematic view of a screwdriver according to the invention;

FIG. 2 is a graph of curves of torque, current and speed of a screwdriver according to the invention during a screwing cycle;

FIG. 3 represents curves illustrating the duration of a torque impulse respectively with a two-stage reduction, the ratio of which is equal to 20.97, and a one-stage reduction, the ratio of which is equal to 3.81;

FIG. 4 represents curves expressing the relationship between the torque applied to the input sun gear of an epicyclic reduction gear or motor shaft and the angle of rotation of the sun gear or of the motor shaft, the output shaft of the tool being immobilized in rotation relative to the body of the tool, respectively with a two-stage reduction, the ratio of which is equal to 20.97 and with a one-stage reduction, the ratio of which is equal to 3.81.

### 6. DESCRIPTION OF ONE EMBODIMENT OF THE INVENTION

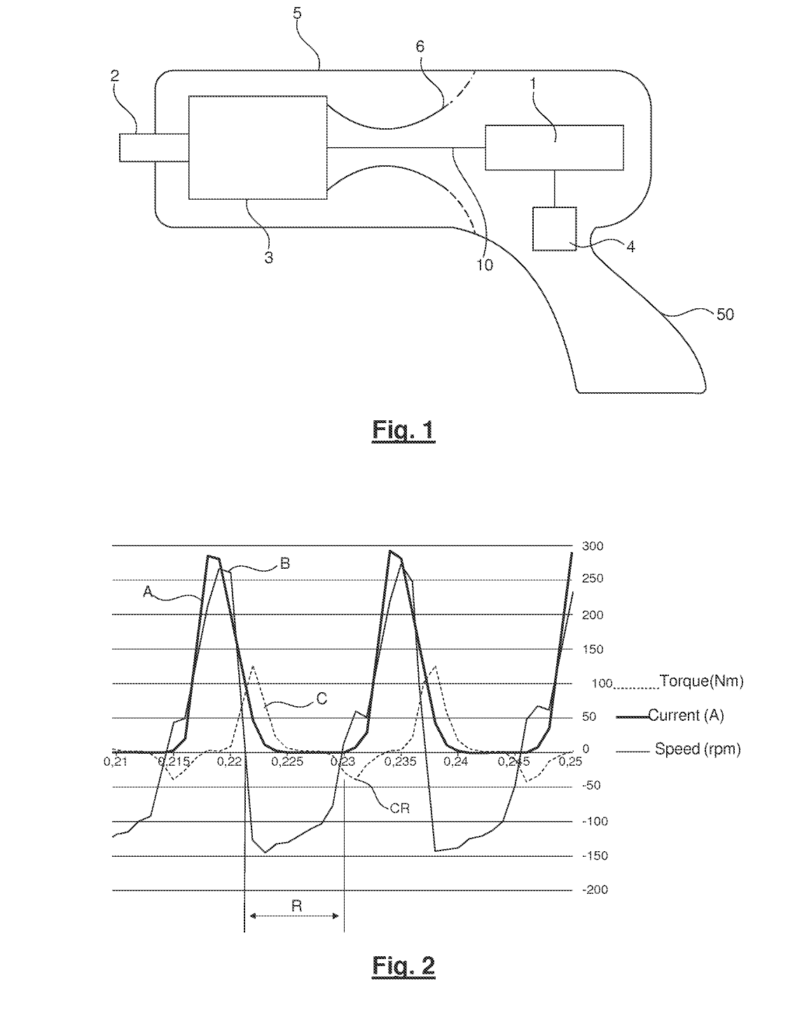

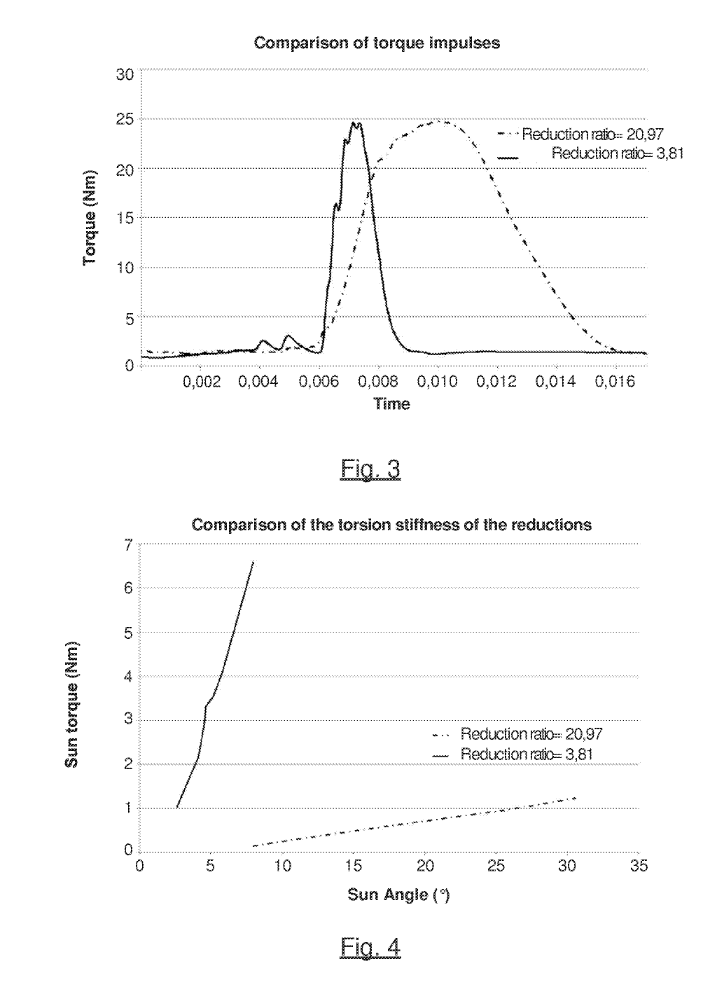

Referring to FIG. 1, an electric screwdriver according to the invention comprises:
motor means (a motor) 1 provided with a rotor 10;
an end member 2 that is to act on a screw to drive the screwing of this screw;
a transmission linking the rotor of the motor means and the end member 2, this transmission including a reduction gear 3;
a driving means (a motor driver) 4 provided to power the motor means 1 in pulsed mode; in other words, these driving means 4 are designed to feed the motor means 1 with a series of impulses, each prompting a motion of rotation of the rotor 10.

These constituent parts are mounted in a housing 5 of the tool, this housing being associated with a handle 50, the housing and the handle being configured, in the present embodiment, to give the screw a shape of a pistol-handle screwdriver.

The reduction gear of the screwdriver comprises an epicyclic train having only one stage, making it possible to:
reduce the gear ratio of the reduction, thus causing a reduction of the duration and intensity of the impulses transmitted to the body of the tool and therefore an improvement in the ergonomy of the tool;
increase the rigidity of the reduction gear, thus causing a reduction of the duration of the pulses and therefore an improvement in the ergonomy of the tool;
improve reliability;
reduce cost price.

The screwdriver furthermore incorporates a torque sensor 6, of the type comprising a deforming element connected to the housing of the tool. The purpose of this torque sensor 6 is to detect the reaching of a set value torque Cc. More specifically, the reduction gear 3 is an epicyclic reduction gear with only one stage, the ring of which is linked rotationally to the housing 5 of the screwdriver by means of the torque sensor 6.

The parameters of the screwdriver are the following:
maximum torque at constant speed of the motor means: Cmax;
reduction ratio of the transmission: R;
transmission efficiency: μ;
set value of torque: Cc.

According to the principle of the invention, the transmission is capable of enabling an accumulation of kinetic energy Ec in the rotor and a restitution of this kinetic energy Ec to the end member 2 between two impulses triggered by the driving means.

Furthermore, the motor means and the reduction gear are configured in such a way that R*μ*Cmax<Cc, the set value torque Cc being reached through the transfer of kinetic energy Ec into the screw to be tightened. The motor means and the reduction gear are configured in such a way that R*μ*Cmax 10 N.m. In other words, it is smaller than or equal to 10/(μCmax).

According to one particular embodiment, the transmission integrates an angular clearance enabling the rotor 10 of the motor means to freely accelerate during an impulse to accumulate kinetic energy Ec.

Referring to FIG. 2, a description is given here below of the evolution of certain operation parameters of a screwdriver according to the invention, illustrated in the form of graphs.

FIG. 2 shows three curves:
the curve A which illustrates the evolution of the current in amperes given by the driving means 4 to the motor means 1;
the curve B illustrating the evolution of the speed expressed in rpm of the rotor 10 of the screwdriver;
the curve C which illustrates a development of the torque transmitted by the end member 2 of the screwdriver to the screw on which the screwdriver is acting.

According to one particular embodiment, the screwdriver furthermore has either of the following characteristics:
the motor means and the reduction gear are configured in such a way that R*μ*Cmax≦Cc/1.5;
Cc>20 N.m.

An embodiment of the invention provides an electric impulse screwdriver, the use of which does not cause any health problems for the operator.

An embodiment of the invention procures a screwdriver of this kind which, in at least one embodiment, prevents the emergence of muscular-skeletal disorders for the operator.

An embodiment of the invention provides a screwdriver of this kind that enables a high level of productivity to be achieved.

An embodiment of the invention procures an electric impulse screwdriver of this kind which makes it possible to attain a pre-screwing speed comparable to that of hydropneumatic tools, i.e. of the order of several thousand revolutions per minute.

An embodiment of the invention provides an impulse screwdriver of this kind which improves its safety of use in at least one embodiment.

An embodiment of the invention provides an impulse screwdriver of this kind which limits the reaction torque undergone by the user because of the screwing operation especially if, at some point, the screwdriver is mistakenly used not in impulse mode but in continuous mode.

1. An electric screwdriver comprising:
a housing;
a motor comprising a rotor and a maximum torque at constant speed of Cmax;
an end member configured to be driven in rotation;
a transmission, which drives the end member and comprises a reduction gear which is coupled to the motor and has a ratio R and an efficiency μ;
at least one torque sensor configured to detect an attainment of a set value torque Cc; and
means for driving (4) a motor driver configured to drive the motor in an impulse mode, in which the motor driver feeds the motor with a series of electric current impulses;
wherein said transmission is configured to enable an accumulation of kinetic energy Ec in the rotor and a restitution to the end member of said kinetic energy Ec between two impulses from the motor driver, and
wherein the motor and the reduction gear are configured in such a way that:
R*μ*Cmax<Cc, the set value of torque Cc being attained through the transfer of kinetic energy Ec to the end member, wherein said ratio R is smaller than or equal to 10/(μCmax).

2. The electric screwdriver according to claim 1, characterized in that wherein said reduction gear is of an epicyclic reduction gear with only one stage.

3. The electric screwdriver according to claim 1, wherein the motor and the reduction gear are configured in such a way that R*μ*Cmax≦Cc/1.5.

4. The electric screwdriver according to claim 1, wherein Cc>20 N.m.

5. The electric screwdriver according to claim 1, wherein said transmission integrates an angular clearance enabling the rotor of the motor to freely accelerate during an impulse to accumulate a kinetic energy Ec.

6. The electric screwdriver according to claim 1, wherein said transmission comprises a ring gear rotationally linked to the housing of the electric screwdriver by the torque sensor.

7. The electric screwdriver according to claim 1, wherein said transmission has a stiffness greater than or equal to 0.5 N.m per degree.
